(19) United States
(12) Patent Application Publication
(10) Pub. No.: US 2010/0207548 A1
(43) Pub. Date: Aug. 19, 2010

(54) LINKING SEQUENCE FOR WIRELESS LIGHTING CONTROL

(76) Inventor: Jeffrey Iott, Monroe, MI (US)

Correspondence Address: Carlson, Gaskey & Olds/Masco Corporation, 400 West Maple Road, Suite 350, Birmingham, MI, 48009, US

(21) Appl. No.: 12/372,034

(22) Filed: Feb. 17, 2009

(51) Int. Cl. H05B 37/02; H01H 9/54

(52) U.S. Cl. 315/362; 307/139

(57) ABSTRACT

A method of linking one of a plurality of wireless switches to a transceiver and control for controlling an electric load comprises the steps of moving the transceiver and control into a linking mode, and actuating the at least one of the plurality of switches through an actuation mode that is distinct from a typical actuation of the switch to request a control operation, such as linking, by the at least one of the transceivers and controls. In addition, a control and a lighting system are claimed.

### BACKGROUND OF THE INVENTION

This application relates to wireless communication between an electric switch and a transceiver and control for receiving signals from the switch, in which a unique sequence of switch actuations is utilized to signal a linking signal.

Traditionally, electric systems such as found in buildings have included wires extending from the switches to various electric loads such as lights, plugs, etc. More recently, switches communicate through a wireless link to a transceiver and control, which then controls the light and provides power to plugs, etc. One known type of switch harvests its own energy, such as by the mechanical actuation taken when the switch is actuated.

One challenge with such systems is that the transceiver and control must be able to identify each switch that sends an actuation signal. Thus, each switch is typically provided with a code of some sort embedded in its signal. The transceiver can receive that code and identify which switch has been actuated such that it knows which electric load to control in response to the signal.

Typically, a linking sequence has been provided wherein the transceiver and control is placed into a linking mode, and the switch is then actuated such that the transceiver and control can learn the code for the appropriate switch.

However, there is a challenge in a building environment in that there are numerous switches that may be actuated at any moment. Thus, should a particular switch that is to be linked to a transceiver and control be actuated in a linking mode, it may well be confused with a signal from a switch in an adjacent room which another occupant has actuated to request a change in a lighting function, as an example.

### SUMMARY OF THE INVENTION

A method of linking one of a plurality of wireless switches to a transceiver and control for controlling an electric load comprises the steps of moving the transceiver and control into a linking mode, and actuating the at least one of the plurality of switches through an actuation mode that is distinct from a typical actuation of the switch to request a control operation, such as linking, by the at least one of the transceivers and controls. In addition, a control and a lighting system are claimed.

These and other features of the present invention can be best understood from the following specification and drawings, the following of which is a brief description.

### BRIEF DESCRIPTION OF THE DRAWINGS

FIG. 1 shows a schematic of a building incorporating electric components.

FIG. 2 shows a linking sequence for the FIG. 1 environment.

### DETAILED DESCRIPTION OF THE PREFERRED EMBODIMENT

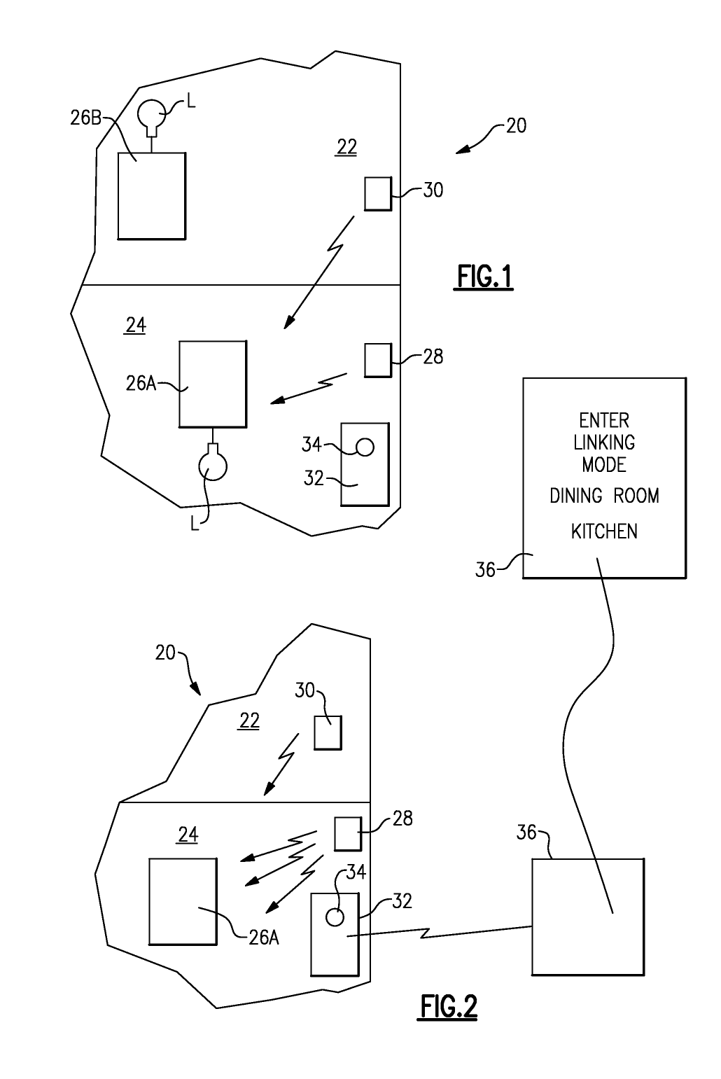

A building 20 is illustrated in FIG. 1, which may have two rooms such as a kitchen 22 and dining room 24. A pair of transceivers and controls 26A and 26B are shown. Each is shown communicating with a light bulb L. A switch 28 may be actuated to send a signal to the transceiver and control 26A to actuate its light bulb L. However, an adjacent switch 30 can also be actuated to send a signal, and that signal will be strong enough such that the transceiver and control 26A may receive the signal even though it is intended for the transceiver and control 26B. In addition, it may well be that more than one switch is associated with the transceiver and control 26A.

Thus, the transceiver and control 26A must be able to identify which switch 28 and 30 is sending a particular signal requesting actuation of an electric load, such as the lights L.

A main control 32 may be associated with each of the transceivers and controls 26A and 26B and has an actuation button 34, which may be actuated to enter a linking mode. A display screen 36 such as may be found on the control 32 is shown in FIG. 2. When an operator enters the linking mode, then the transceiver and control 26A prepares to receive a signal, which it can then associate with a particular switch 28 or 30. As an example, the display screen 36 is shown providing options for dining room 24 and kitchen 22. Thus, in the linking mode, an operator will select one of the two room options, and then actuate the associated switch such that the transceivers and controls can learn the code associated with that switch.

However, in actual building environments, it is quite possible that an occupant of the room 22 will actuate the switch 30 when an occupant of the room 24 is attempting to link switch 28 to the transceiver and control 26A.

Thus, the present invention discloses a sequence such as illustrated in FIG. 2. When the control 32 is moved into the linking mode for the transceiver and control 26A, the switch 28 is placed through a sequence of operation that would be distinct from the typical actuation of another switch such as switch 30. Thus, as shown in FIG. 2, the switch 28 has been actuated three times rapidly to send three identical signals to the transceiver and control 26A. The transceiver 26A is programmed to only link to a signal that is received within the predetermined sequence. Of course, sequences other than three rapid actuations may be utilized. In addition, the rapid actuations would need to occur within a short period of time (within two seconds, for example).

With this unique linking protocol, the present invention is able to properly link each of the switches to their respective transceivers and controls.

The transceiver and control may be such as are available from EnOcean under its product number TCM220C. The wireless switches may be known, and available from EnOcean under its product number PTM200C. Of course, any other type of transceiver, control or switch may be utilized within the scope of this invention.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of linking one of a plurality of wireless switches to at least one of a plurality of transceivers and controls for controlling an electric load comprising the steps of:
moving said at least one of said plurality of transceivers and controls into a linking mode; and
actuating said at least one of said plurality of switches through an actuation mode that is distinct from a typical actuation of the switch to request a control operation by said at least one of said transceivers and controls.

2. The method as set forth in claim 1, wherein said linking mode includes a plurality of actuations of said at least one switch within a predetermined period of time.

3. A lighting system for a building comprising:
at least one transceiver and control having a linking mode;
a plurality of switches, each of said switches having an actuation member that generates a signal, and said signal including an embedded code identifying a particular one of said plurality of switches;
said at least one transceiver and control for receiving said signal, and for actuating an electric load in response to said signal; and
said linking mode requiring an actuation sequence of one of said plurality of switches to cause said control to store the embedded code associated said one of said plurality of switches.

4. The system as set forth in claim 3, wherein said linking mode includes a plurality of actuations of said at least one switch within a predetermined period of time.

5. A lighting control to be used in a building comprising:
a transceiver and control programmed to be able to enter a linking mode in which it can receive a signal from a wireless switch, and associate a code embedded in said wireless signal to a particular one of a plurality of wireless switches, and said signal including a predetermined sequence of actuations by said at least one of the switches which instructs the at least one transceiver and control to store the code associated with said signal in the linking mode.
